(19) United States
(12) Patent Application Publication
(10) Pub. No.: US 2023/0265927 A1
(43) Pub. Date: Aug. 24, 2023

(54) FLEXIBLE SEALING MEMBRANE AND SEAL ASSEMBLY FOR ROTARY SHAFT EQUIPMENT

(71) Applicant: John Crane Inc., Morton Grove, IL (US)

(72) Inventors: Brian Kalfrin, Pearland, TX (US); Walter Wrona, Niles, IL (US); Syed Niamathullah, Morton Grove, IL (US); Jim Spiegelman, Arlington Heights, IL (US); Thomas Steigerwald, Chicago, IL (US)

(21) Appl. No.: 18/156,723

(22) Filed: Jan. 19, 2023

Related U.S. Application Data
(60) Provisional application No. 63/301,115, filed on Jan. 20, 2022.

(51) Int. Cl. F16J 15/36

(52) U.S. Cl. CPC F16J 15/36

(57) ABSTRACT

A flexible sealing membrane for use in a rotary seal. The membrane can be an annular flexible sealing membrane that includes a flange portion, a coaxial portion that is axially fixable relative to a shaft and a flexible connection portion positioned within a radially inward extent of the first flange portion and connecting the first flange portion to the first coaxial portion.

### CROSS REFERENCE TO RELATED APPLICATIONS

This application claims the benefit of an earlier filing date from U.S. Provisional Application Ser. No. 63/301,115 filed Jan. 20, 2022, the entire disclosure of which is incorporated herein by reference.

### TECHNICAL FIELD

This invention relates to rotary shaft equipment having mechanical seal assemblies providing a seal between a housing and rotatable shaft of the rotary shaft equipment. More particularly, it relates to such rotary shaft equipment and seal assemblies that include a secondary sealing membrane.

### BACKGROUND

Mechanical seals are used to provide a seal between a rotating shaft and a stationary housing of a pump, compressor, turbine, or other rotating machine. End face mechanical seals generally include a primary seal interface comprising two relatively rotatable seal faces defined or otherwise carried by so called “primary” and “mating rings.” Frictional wear between the seal faces can cause a gap to form therebetween, leading to excessive leakage. Accordingly, some end face seals require regular adjustment in order to maintain the appropriate or axial position of an axially shiftable seal member (also known as “seal height”) in order to account for such wear.

Various biasing mechanisms have been contemplated to provide a closing force to automatically accommodate wear. Such biasing mechanism have included single and multiple coil springs, and metal bellows.

Pusher seal assemblies comprise a dynamic secondary seal (such as an o-ring) to provide a seal between the shaft and the seal members themselves. The dynamic secondary seal of pusher seals is generally configured to move axially with the axially shiftable seal member/primary ring. This axial movement relative to the shaft can cause fretting or shredding of the secondary seal due to friction.

Non-pusher seals generally feature a secondary shaft seal that is not intended to move axially relative to the shaft. The depicted mechanical seal comprises an elastomeric bellows that is driven to rotate with the shaft relative to the housing. This can create an axial load on the elastomeric bellows which can cause the elastomer to rigidly collapse. This axial rigidity prevents the bellows from effectively counteracting the closing force provided by the biasing members, leading to excess face pressure, frictional wear, and eventual seal failure.

Ongoing demand for improved productivity, reliability, durability and changing envelope requirements for pumps and other rotary shaft equipment dictate continued effort for new developments in seal assemblies.

### SUMMARY

Embodiments of the present disclosure meet the need for mechanical seals that can operate with a vaporizing liquid or a pure vapor phase fluid by providing a flexible sealing membrane for incorporation in a mechanical seal assembly for with rotary shaft equipment. The flexible sealing membrane can be more flexible than those in some other seals.

The flexible sealing membrane can be implemented according to one or more different embodiments. A first embodiment an annular flexible sealing membrane that includes a flange portion, a coaxial portion that is axially fixable relative to a shaft and a flexible connection portion positioned within a radially inward extent of the first flange portion and connecting the first flange portion to the first coaxial portion. The flange portion can have front face and a back face that in operation will be disposed between a primary ring and biasing mechanism. Removing material from a flat contact plane (either front or back) can be used to increase contact pressure or affect distortion of primary ring

Another embodiment can also include an annular flexible sealing membrane that includes a flange portion, a coaxial portion that is axially fixable relative to a shaft and a flexible connection portion positioned within a radially inward extent of the first flange portion and connecting the first flange portion to the first coaxial portion. The flange portion can have front face and a back face that in operation will be disposed between a primary ring and biasing mechanism. In this embodiment, an extension of the front face can be formed such that it wraps around the primary ring in order to resist flange deformation and promote sealing between the primary ring and sealing membrane

Another embodiment, can also include an annular flexible sealing membrane that includes a flange portion, a coaxial portion that is axially fixable relative to a shaft and a flexible connection portion positioned within a radially inward extent of the first flange portion and connecting the first flange portion to the first coaxial portion. In this embodiment, the flexible connection portion can be such that it presents a small convolution of additional elastomer material to the membrane at the balance diameter. This embodiment may improve flexibility of the membrane as compared to other prior art membranes and reduce distortion of the membrane through the working height range while maintaining hydraulic balance. This would result in improved sealing between the primary ring and the membrane.

In a first embodiment, a mechanical seal assembly adapted for arrangement around a rotating shaft of a rotating device is disclosed. The mechanical seal assembly includes: a primary ring that, in operation, is axially shiftable relative to the rotating shaft and includes a primary ring seal face and primary ring outboard face; a mating ring that, in operation, is axially fixed relative to the rotating shaft; a biasing mechanism that urges the primary ring toward the mating ring to form a seal interface between the primary ring seal face and a seal face of the mating ring with a closing force; and an annular flexible sealing membrane. The membrane includes: a flange portion arrangeable between the primary ring and the biasing mechanism, the flange portion being axially shiftable relative to the rotating shaft, the flange portion including inboard face and an outboard face, wherein the inboard face is arranged and configured such that it includes one or more depressions formed therein that form one or more contact regions that contact the primary ring outboard face; a flexible connection portion positioned within a radially inward extent of the flange portion, wherein the flexible connection portion includes an angular facet that extends from the flexible portion in an axial outward direction; and a coaxial portion extending axially from the flexible connection portion, the coaxial portion held axially fixed relative to the stub sleeve.

In any prior embodiment, the one or more contact regions may define the inboard face and wherein the flange portion includes a flange thickness T_{f} measured between the inboard face and the outboard face.

In any prior embodiment, the inboard face may include at least two depressions and wherein the one or more contact regions includes a single contact region formed between the at least two depressions.

In any prior embodiment, the inboard face can include one depression and wherein the one or more contact regions includes two contact regions formed on opposing sides of the depression.

In any prior embodiment, the inboard face can include at least three depressions formed as circles removed or molded into the inboard face and wherein the one or more contact regions includes at least four circular contact regions.

In any prior embodiment, the depressions may define a recessed face in the inboard face and the thickness of the flange portion between the recessed face and the outboard face is less than T_{f}.

In any prior embodiment, the outboard face of the flange portion can include an outboard depression formed therein to define an outboard recessed surface.

In any prior embodiment, a thickness of the flange portion measured between the outboard recessed surface and the inboard face is less than T_{f}.

In any prior embodiment, the coaxial portion includes an outer face and an inner face radially inward from the outer face, where the coaxial portion has a coaxial thickness T_{c} measured between the inner face and the outer face.

In any prior embodiment, the outer surface includes an outer depression formed therein that defines an outer recessed face, wherein a distance between the outer recessed face and the inner face is less that the coaxial thickness T_{c}. The outer surface can also include an inner depression formed therein that defines an inner recessed face, wherein a distance between the inner recessed face and the outer face is less that the coaxial thickness T_{c}.

In a second embodiment, a mechanical seal adapted for arrangement around a rotating shaft of a rotating device is disclosed. In this embodiment, the mechanical seal assembly comprises: a primary ring that, in operation, is axially shiftable relative to the rotating shaft and includes a primary ring seal face and primary ring outboard face; a mating ring that, in operation, is axially fixed relative to the rotating shaft; a biasing mechanism that urges the primary ring toward the mating ring to form a seal interface between the primary ring seal face and a seal face of the mating ring with a closing force; and an annular flexible sealing membrane. The membrane includes a flange portion arrangeable between the axially shiftable first seal ring and the biasing mechanism, the flange portion being axially shiftable relative to the rotating shaft, the flange portion including an inboard face contacting the primary ring and an outboard face. The outboard face of the flange portion includes an outboard depression formed therein to define an outboard recessed surface. The membrane also includes: a flexible connection portion positioned within a radially inward extent of the flange portion, wherein the flexible connection portion includes an angular facet that extends from the flexible portion in an axial outward direction; and a coaxial portion extending axially from the flexible connection portion, the coaxial portion held axially fixed relative to the stub sleeve.

In this second embodiment, the flange portion includes a flange thickness T_{f} measured between the inboard face and the outboard face.

In this second embodiment, a thickness of the flange portion measured between the outboard recessed surface and the inboard face is less than T_{f}.

In any prior embodiment of the second embodiment, the coaxial portion includes an outer face and an inner face radially inward from the outer face, where the coaxial portion has a coaxial thickness T_{c} measured between the inner face and the outer face.

In any prior embodiment of the second embodiment, the outer surface includes an outer depression formed therein that defines an outer recessed face, wherein a distance between the outer recessed face and the inner face is less that the coaxial thickness T_{c}.

In another embodiment a method of forming an annular flexible sealing membrane for use in a mechanical seal assembly that includes a primary ring, a mating ring and a biasing mechanism that urges the primary ring toward the mating ring to form a seal interface between the primary ring seal face and a seal face of the mating ring with a closing force is disclosed. The method includes providing an annular flexible sealing membrane that includes: a flange portion arrangeable between the primary ring and the biasing mechanism, the flange portion being axially shiftable relative to the rotating shaft, the flange portion including inboard face and an outboard face; a flexible connection portion positioned within a radially inward extent of the flange portion, wherein the flexible connection portion includes an angular facet that extends from the flexible portion in an axial outward direction; and a coaxial portion extending axially from the flexible connection portion, the coaxial portion held axially fixed relative to the stub sleeve. The method also includes forming one or more depressions in the inboard face to define one or more contact regions configured to contact the primary ring outboard face. The one or more contact regions define the inboard face and wherein the flange portion includes a flange thickness T_{f} measured between the inboard face and the outboard face.

In any prior method, the inboard face can include: at least two depressions and wherein the one or more contact region is a single circular contact region formed between the at least two depressions; one depression and wherein the one or more contact regions are circular and includes two contact regions formed on opposing sides of the depression; one depression and wherein the one or more contact regions includes a single contact region formed on opposing sides of the depression; or at least three depressions formed as circles removed or molded into the inboard face and wherein the one or more contact regions are circular and includes at least four contact regions. Any of the contact regions can be circular.

In any prior method, the depressions define a recessed face in the inboard face and the thickness of the flange portion between the recessed face and the outboard face is less than T_{f}.

In any prior method, the outboard face of the flange portion can include an outboard depression formed therein to define an outboard recessed surface.

In any prior method, a thickness of the flange portion measured between the outboard recessed surface and the inboard face is less than T_{f}.

In any prior method, the coaxial portion can include an outer face and an inner face radially inward from the outer face, where the coaxial portion has a coaxial thickness T_{c} measured between the inner face and the outer face.

In any prior method, the outer surface includes an outer depression formed therein that defines an outer recessed face, wherein a distance between the outer recessed face and the inner face is less that the coaxial thickness T_{c}.

In any prior method, the outer surface include an inner depression formed therein that defines an inner recessed face, wherein a distance between the inner recessed face and the outer face is less that the coaxial thickness T_{c}.

In a third embodiment, a mechanical seal assembly adapted for arrangement around a rotating shaft of a rotating device is disclosed. The seal of this embodiment includes: a primary ring that, in operation, is axially shiftable relative to the rotating shaft and includes a primary ring seal face, a membrane contacting face radially outward of primary ring seal face, a primary ring outboard face and a primary ring outer face between the primary ring outboard face and the membrane contacting face; a mating ring that, in operation, is axially fixed relative to the rotating shaft; a biasing mechanism that urges the primary ring toward the mating ring to form a seal interface between the primary ring seal face and a seal face of the mating ring with a closing force; and an annular flexible sealing membrane. The membrane can include: a flange portion arrangeable between the primary ring and the biasing mechanism, the flange portion being axially shiftable relative to the rotating shaft, the flange portion including inboard face and an outboard face, wherein the flange portion includes an outer extension that extends inboard relative to the inboard face and is arranged to contact the primary ring outer face; a flexible connection portion positioned within a radially inward extent of the flange portion, wherein the flexible connection portion includes an angular facet that extends from the flexible portion in an axial outward direction; and a coaxial portion extending axially from the flexible connection portion, the coaxial portion held axially fixed relative to the stub sleeve.

In any prior embodiment of the third embodiment, the flange portion can further include an inward extension that extends radially inward from the outer extension and contacts membrane contacting face of the primary ring.

In any prior embodiment of the second embodiment, the membrane contacting face of the primary ring can be outboard of the primary ring seal face.

In any prior embodiment of the second embodiment, the membrane contacting face of the primary ring is planer with the primary ring seal face.

In fourth embodiment, a mechanical seal assembly adapted for arrangement around a rotating shaft of a rotating device is disclosed. The mechanical seal assembly comprises: a primary ring that, in operation, is axially shiftable relative to the rotating shaft and includes a primary ring seal face, a membrane contacting face radially outward of primary ring sela face, a primary ring outboard face and a primary ring outer face between the primary ring outboard face and the membrane contacting face; a mating ring that, in operation, is axially fixed relative to the rotating shaft; a biasing mechanism that urges the primary ring toward the mating ring to form a seal interface between the primary ring seal face and a seal face of the mating ring with a closing force; and an annular flexible sealing membrane. The membrane includes: a flange portion arrangeable between the primary ring and the biasing mechanism, the flange portion being axially shiftable relative to the rotating shaft, the flange portion including inboard face and an outboard face; a coaxial portion extending axially relative to the flange portion, the coaxial portion held axially fixed relative to the stub sleeve; and a flexible connection portion that connects the flange portion to the axial portion, the flexible connection portion including a convolution that extends outboard from the outboard face and an extension that connects the convolution to the coaxial portion, wherein the extension extends in an inboard direction from the convolute portion to the axial portion.

The convolution can be at or above a balance diameter of the seal.

In the fourth embodiment, a thickness of the extension is can be the larger than a thickness of the flange portion.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures wherein:

FIG. 1 is a cross-sectional view depicting a portion of a seal assembly that includes non-collapsible flexible sealing membrane according to a prior art seal that will be used to provide a general understanding (in combination with FIG. 2) of how seal that includes flexible sealing membrane operates;

FIG. 2 is a cross-sectional view depicting a detail of the seal assembly of FIG. 1 according to an embodiment;

FIGS. 3A and 3B show a cross section of a seal assembly and a detailed view of a membrane according to one embodiment;

FIGS. 4A and 4B show a cross section of a seal assembly and a detailed view of a membrane according to one embodiment;

FIGS. 5A and 5B show a cross section of a seal assembly and a detailed view of a membrane according to one embodiment;

FIG. 6 shows a detailed view of a membrane according to one embodiment;

FIGS. 7A and 7B show a cross section of a seal assembly and a detailed view of a membrane according to one embodiment; and

FIGS. 8A and 8B show a cross section of a seal assembly and a detailed view of a membrane according to one embodiment.

The diagrams depicted herein are illustrative. There can be many variations to the diagram or the operations described therein without departing from the spirit of the invention. For instance, the actions can be performed in a differing order or actions can be added, deleted or modified. Also, the terms “coupled”, “connected” and variations thereof describes having a path for a fluid between two elements and does not imply a direct connection between the elements with no intervening elements/connections between them. However, all connections or couplings can be direct if specifically called out the claims and all instances of such connections/connections can include the description that the connection/coupling (or similar terms) are direct. All of these variations are considered a part of the specification.

### DETAILED DESCRIPTION

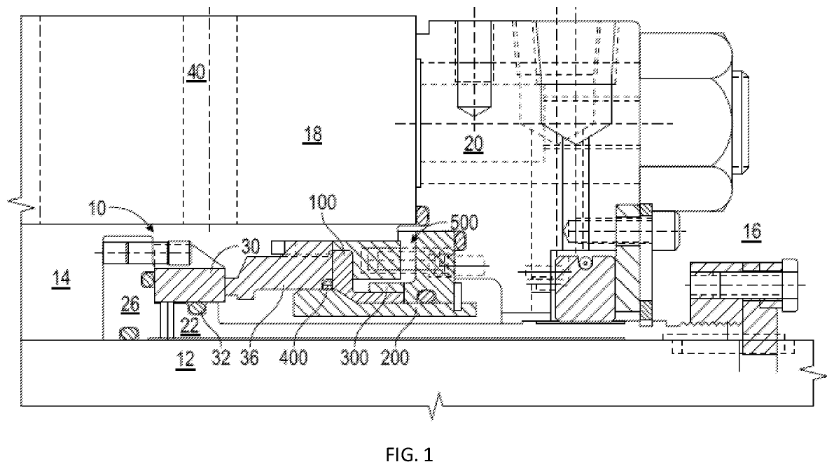

FIG. 1 is a cross-sectional views depicting a portion of a seal assembly 10 including a flexible sealing membrane 100 depicted in conjunction with an article of rotary shaft equipment such as compressor or a pump.

As is common for seal assemblies of this type, seal assembly 10 can seal a rotating, axially extending, shaft 12 of an article of rotary shaft equipment. Seal assembly 10 can provide a seal for the process chamber 14 at the inboard extent of the seal assembly 10 with respect to the ambient surroundings 16. In one embodiment that can exist in this and all other embodiments, the process chamber 14 includes a vaporizing liquid or a pure vapor phase fluid.

The seal assembly 10 can be arranged coaxial of the shaft 12 in a bore defined by an annular housing 18 (e.g., a body of a rotary machine) coaxial of the shaft 12. Various stationary (or non-rotating) components of seal assembly 10 can be operably coupled to the housing 18 or another element such as a gland plate generally indicated by reference number 20, which is in turn also operably coupled to housing 18.

Various rotating components can be operably coupled to shaft 12, for rotation therewith. An annular sleeve member 22 is secured to the shaft 12 for rotation therewith. An annular flange formation 26 extends radially outwardly of the sleeve member 22 at the end thereof adjacent the process chamber 14.

An axially fixed seal ring 30 (or mating ring) is mounted on the face of the annular flange formation 26 remote from the process chamber 14, for rotation therewith. Annular o-ring 32 provides a resilient secondary seal between sleeve member 22 and axially fixed seal ring 30. In embodiments, more or fewer secondary sealing o-rings may be present. Axially fixed seal ring 30 includes outboard sealing face 50.

An axially shiftable seal ring 36 (or primary ring) is arranged outboard and adjacent to axially fixed seal ring 30. Axially shiftable seal ring 36 includes inboard sealing face 52. Inboard sealing face 52 abuts outboard sealing face 50.

While, as depicted and described, axially shiftable seal ring 36 is stationary and axially fixed seal ring 30 is rotatable, in embodiments, the relative axial movement can be provided by either the rotating or stationary seal ring.

Inlet 40 can be defined within housing 18 and/or gland plate 20 to provide a sealing lubricant (not shown) to sealing faces 50 and 52.

In the following discussion, direction A shall be referred to as the outboard direction (with the opposite direction being inboard direction B.

Annular bellows, or sealing membrane 100 can present a generally L-shaped cross-section, comprising a first, generally radially outward extending, flange portion 102 and a second, generally axially outboard extending, coaxial portion 104. Flange portion 102 and coaxial portion 104 can be operably coupled by a flexible connecting portion 106. An inboard face of flange portion 102 can abut outboard face of axially shiftable seal ring 36, creating a pressure tight seal.

Coaxial portion 104 is substantially or entirely radially inward of the balance diameter of the seal, where the pressure differential across the seal is the greatest. Flexible connecting portion 106 can present an angular facet 108 at a radially inward side and a connecting angle θ between flange portion 102 and coaxial portion 104 at a radially outward side. In embodiments, angle θ can be approximately ninety degrees, though other angles may also be used. Flexible connecting portion 106 can present a thinner cross section than flange portion 102 or coaxial portion 104 to enable stretching and compression.

Angular facet 108 can terminate at corner 110 at a radially inward extent of flexible connecting portion 106. Facet 108 can present an angle ϕ, relative to the axial axis of between about 100° to about 150°. In some embodiments below, the angle could be 90v. Sealing membrane 100 is non-collapsible and can comprise a flexible material. Example flexible materials include elastomers such as nitrile, fluoroelastomer, and ethylene propylene rubbers, though other materials can be used.

Coaxial portion 104 is fixed to an annular stub sleeve 200 by annular band 300. The stub sleeve 200 has a first outer diameter D1, a second outer diameter D2 and an angled surface 112 connecting the first outer diameter to the second outer diameter. D2 is greater than D1. Radially outward directed faces (D1, angled surface 112 and D2) of stub sleeve 200 can abut coaxial portion 104, facet 108, and axially shiftable seal ring 36, respectively. Stub sleeve 200 can have a groove 202 to receive snap ring 204 to locate stub sleeve axially relative to carrier 504 (discussed below). In embodiments, stub sleeve 200 can be located radially by snap ring 204, hydraulic pressure, or interference fit with carrier 504 (discussed below) or other components of seal assembly 10. Stub sleeve 200, band 300, and snap ring 204 can comprise steel or stainless steel in embodiments.

Annular anti-extrusion ring 400 can be present in an annular groove of axially shiftable seal ring 36 and abut axially shiftable seal ring 36, stub sleeve 200, and sealing membrane 100. Annular anti-extrusion ring 400 can comprise a harder elastomer than sealing membrane 100, such as a 50 to 55 (Shore D) durometer carbon filled polytetrafluoroethylene (PTFE). Because extrusion is most likely at the balance diameter of the seal, the inner diameter of anti-extrusion ring 400 can be arranged at the balance diameter of the seal.

Biasing mechanism 500 can abut flange portion 102. Biasing mechanism 500 can comprise an axially shiftable annular retainer 502, axially fixed carrier 504, and one or more biasing members 506 spanning therebetween. Retainer 502 can be arranged proximate flange portion 102. Retainer 502 can present protrusion 508, extending axially inboard outside the outer diameter of flange portion 102. Protrusion 508 can be radially spaced from the outer face of flange portion 102. Carrier 504 can be axially and rotationally fixed to gland plate 20 by one or more pins 510, though other fixation mechanisms can be used. Biasing members 506 can comprise one or more radially spaced springs, though other biasing mechanisms known in the art can be used. In embodiments, one or both of retainer 502 and carrier 504 can include bores adapted to house at least part of each biasing member 506, such that biasing members 506 are partially located within retainer 502 and carrier 504.

The stub sleeve 200, the carrier 504, the band 300 and the snap ring 204 can be sized and arranged such that they hold the sealing membrane 100. As illustrated, axial portion 104 of the sealing membrane is disposed between the sleeve 200 and the band 300. More details of the sealing membrane 100 are discussed below.

An annular anti-extrusion ring 220 can be present in an annular groove of axially shiftable seal ring 36 and abut or be proximate to the coaxial portion 104 or other portions of the sealing membrane 100 and the stub sleeve 200. The annular anti-extrusion ring 220 can comprise a harder elastomer than sealing membrane 100, such as a 50 to 55 (Shore D) durometer carbon filled polytetrafluoroethylene (PTFE). In one embodiment, because extrusion is most likely at the balance diameter of the seal, the inner diameter of anti-extrusion ring 220 can be arranged at the balance diameter of the seal assembly 10.

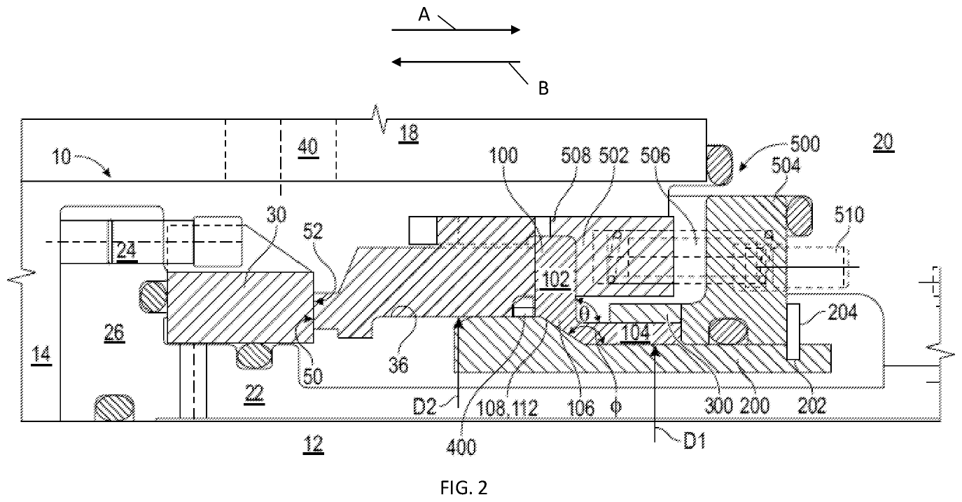

Those of ordinary skill in the art will appreciate that the arrangement depicted in FIG. 2 includes components that may be altered or eliminated in other seal assembly embodiments. In addition, more or fewer components may be incorporated in other embodiments of seal assemblies according to the present disclosure.

In operation, rotation of the shaft 12 can drive sleeve member and axially fixed seal ring 30 to rotate relative to axially shiftable seal ring 36. Seal lubricant (not shown) can optionally be provided to seal assembly 10 through one or more inlets 40 provided in housing 18 to lubricate the seal sealing faces 50 and 52 and to create a pressure gradient across sealing faces 50 and 52.

The pressure gradient and hydraulic pressure created by the relative rotation of the sealing faces 50 and 52 can result in an opening force, urging axially shiftable seal ring 36 axially outboard (direction A) from the axially fixed seal ring 30. Similarly, a closing force can be provided by the biasing mechanism 500, urging axially shiftable seal ring 36 inboard toward axially fixed seal ring 30.

Those of ordinary skill in the art will appreciate that the closing force at a seal face interface can be calculated from the closing area (AC), the opening area (AO), the outer diameter of the stationary ring face (OD), the inner diameter of the stationary ring face (ID) and the balance diameter (BD), as detailed below:

$$Closing Force = ( \frac{A C}{AO} ) \times Hydraulic Pressure$$

$$where AC = \frac{{OD}^{2} - B {D}^{2}}{{OD}^{2} - {ID}^{2}}$$

The flange portion 102 can shift (or otherwise translate) axially and radially based on the relative closing and opening forces, and the axial translation of the shaft itself, such that the closing force applied to axially shiftable seal ring 36 is constant, regardless of the position of flange portion 102.

As discussed above and with further reference to FIG. 2, motion of the shiftable seal ring 36 will cause the flange portion 102 to move axially inboard/outboard. The difference in thickness between the flange/coaxial portions 102, 104 will allow for such flexion while the inner portion is held axially fixed relative to the housing 18 by the stub sleeve 200.

Over the life of the seal, sealing faces 50 and 52 will wear relative to each other. Because sealing membrane 100 can move inboard, toward process chamber 14, and outward, away from process chamber 14, over the life of the seal, it can help to maintain an appropriate seal gap. Hydraulic pressure can keep the axially shiftable seal ring 36 from contacting axially fixed seal ring 30 while the flange portion 102 of sealing membrane 100 moves inboard. Biasing mechanism 500 can be used to set the working height of the seal and compress flange portion 102 of sealing membrane 100 against an end of the axially shiftable seal ring 36 (distal in relation to the process chamber, and opposite sealing face 52) of the axially shiftable seal ring 36 (creating a seal) when no hydraulic pressure is present.

The maximum axially outboard translation of flange portion 102 and retainer 502 can be defined by a gap provided between an outboard face of retainer 502 and an inboard face of the fixed carrier, or by the compression limit of biasing members 506. In embodiments, translation of flange portion 102 can be limited to prevent folding over, or other collapsing of sealing membrane 100.

In addition, because flange portion 102 is held in a radially extending orientation by axially shiftable seal ring 36 and retainer 502, coaxial portion 104 is held in an axially extending orientation by the stub sleeve 200, the sealing membrane 100 is non-collapsible.

The previously described embodiments can be utilized with variations of the membrane as disclosed herein. That is, all of the membranes disclosed herein can be utilized with a rotating seal that includes a primary ring and a mating ring as generally shown above. As will be understood, in one or more instances at least the stub sleeve can be modified from that shown above to be compatible to other versions of the sealing membrane 100. Of course, other elements could also be omitted, added or modified as needed.

Embodiments herein provide membrane designs that may be more effective in environments where mechanical seal product is intended to operate in the presence of a vaporizing liquid and possibly a pure vapor phase fluid.

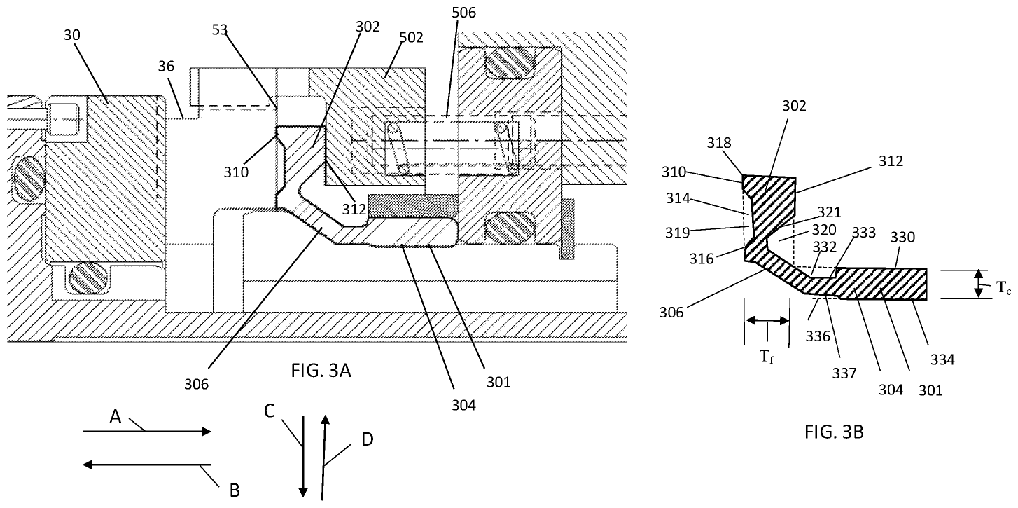

In the following discussion, certain different embodiments of membranes will be shown. In some of these, portions of the sealing membrane 100 have been removed. Such removal can allow for one or both of greater flexibility and increased pressure between the membrane and the outboard face 53 (FIG. 3) of the primary ring 36. From time to time, the membrane 100 may be shown in dashed lines compared to one or more of the following embodiments to illustrate such removal. Also, different versions of mating and primary rings are shown in the figures that follow but it shall be understood that the rings can be same or similar to those shown above. The embodiments shown, for example, in FIGS. 3-6 can be formed by starting with a membrane such a membrane 100 and removing portions thereon. It should be noted, however, that such embodiments can be formed by adding portions to membrane 100 or by molding membranes with the disclosed or similar characteristics. Further, in some cases, both molding and removal can be utilized

One such embodiment is shown in FIGS. 3A and 3B. In this embodiment, a membrane 301 is illustrated. The membrane 301 can present a generally L-shaped cross-section, comprising a first, generally radially outward extending, flange portion 302 and a second, generally axially outboard extending, coaxial portion 304. Flange portion 302 and coaxial portion 304 can be operably coupled by a flexible connecting portion 306.

The flange portion 302 includes inboard face 310 and an outboard face 312. The inboard face 310 of flange portion 302 can abut outboard face 53 of axially shiftable seal ring 36 (also referred to as mating ring herein), creating a pressure tight seal. The outboard face 312 can be contacted by and urged towards the mating ring 30 by retainer 502 and biasing members 506 as discussed above.

Coaxial portion 304 is substantially or entirely radially inward of the balance diameter of the seal, where the pressure differential across the seal is the greatest. Flexible connecting portion 306 can present a thinner cross section than flange portion 302 or coaxial portion 304 to enable stretching and compression.

The inboard face 310 can be formed or modified such that includes one or more inboard depressions 314 formed therein. Such depressions will result in the formation of one or more contact points 316, 318 that, in operation, contact the outboard face 53 of axially shiftable seal ring 36 and a recessed face 319 that does not contact outboard face 53 of axially shiftable seal ring 36. As shown in the figures, the contact points 316, 318 are discrete points but the skilled artisan will realize that this is due the cross-sectional nature of the view. Thus, the contact points can also be referred to as contact regions and are circular in one or more embodiments. As compared to the embodiment of FIG. 2, having the depression/recessed face will result in reduced contact area between the outboard face 53 of axially shiftable seal ring 36 and the inboard face 310 of the membrane 301 resulting in increased contact pressure and better sealing. Thus, in one embodiment, disclosed is a membrane that portions removed from its inboard face. As show, the single depression 314 results in the creation of two contact points 316, 318 on opposing sides thereon.

In addition, portions of the outboard face 312 and the coaxial portion 304 can be removed (or otherwise formed to have less material than membrane 100). While shown in the same figure, it shall be understood that removal of portions of the inboard face 310 can be done without removal of portions outboard face or the coaxial portion. That is, while removal is shown to all three portions of the membrane 301, any combination of the three possibilities (or only one) is contemplated as being within the scope of the disclosure.

As shown, an outboard depression 320 is formed in the outboard face 312 to create an outboard recessed surface 321.

In FIG. 3B, the flange portion 302 is shown as having a flange thickness T_{f} measured between the furthest inboard and outboard faces 310, 312 of the flange. The inboard depression 314 is formed such that a distance (thickness) from the recessed face 319 to the outboard face 312 is less than the flange thickness T_{f}. Similarly, the outboard depression 312 is formed such a distance (thickness) from the outboard recessed face 321 to the inboard face 310 is less than the flange thickness T_{f}. In the case where both inboard and outboard depressions 314, 320 are present, the thickness between the inboard and outboard recessed faces 319, 321 is less than T_{f} or the other thicknesses just described.

In a similar manner, the coaxial portion 304 also can have portions removed. Again, while portions of both the coaxial and flange portions 302, 304 are shown as being removed in FIGS. 3A, 3B, embodiments herein do not need both.

The coaxial portion 304 has coaxial thickness T_{c} and as shown, an outer depression 332 is formed in the outer face 330 to create an outboard recessed surface 321. The coaxial portion also in inner depression 336 formed on an inner face 334 of the coaxial portion 304. The coaxial thickness T_{c} is measured between the furthest inner and outer b 334, 330 of the coaxial portion 304. In this and all other embodiments, the inner face 334 is radially inward (direction C with direction D being radially outward) from the outer face 330. The inner depression 336 is formed such that a distance (thickness) from the inner recessed face 337 to the outer face 330 is less than the coaxial portion thickness T_{c}. Similarly, the outer depression 332 is formed such a distance (thickness) from the outer recessed face 333 to the inner face 334 is less than the coaxial portion thickness T_{c}. In the case where both inner and outer depressions 332, 336 are present, the thickness between them is less than T_{c} or the other thicknesses just described related to the coaxial portion 304.

In the above example it is noted that removing material (or otherwise forming the above described depressions) from one of both of the outboard face 312 of the flange 302 and inner and/or outer faces 334, 330 of the coaxial portion 304 can make the membrane more flexible at least as compared to the flexibility of the membrane 100 as described above.

As above, the sealing membrane 301 is non-collapsible and can comprise a flexible material. Example flexible materials include elastomers such as nitrile, fluroreslastomer, and ethylene propylene rubbers, though other materials can be used.

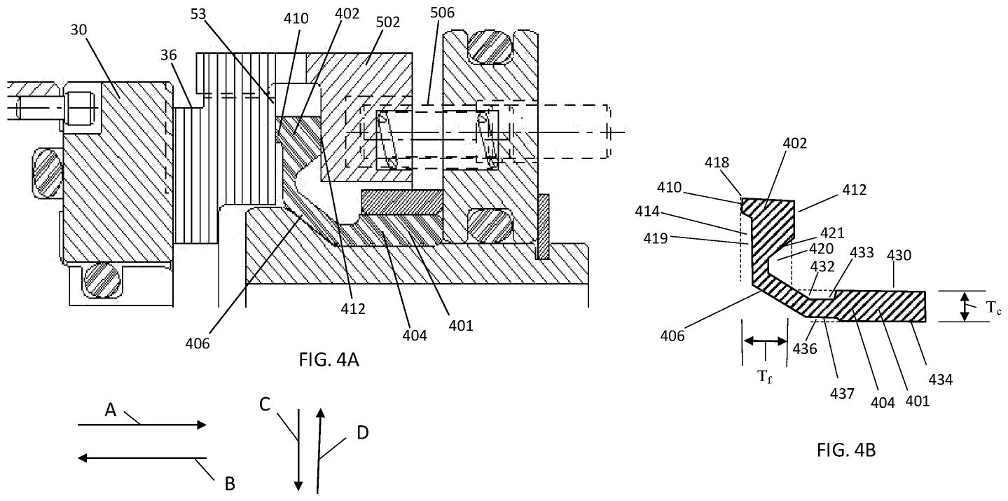

Another embodiment is of a sealing membrane 401 is shown in FIGS. 4A and 4B. In this embodiment, a membrane 401 is illustrated. The membrane 401 can present a generally L-shaped cross-section, comprising a first, generally radially outward extending, flange portion 402 and a second, generally axially outboard extending, coaxial portion 404. Flange portion 402 and coaxial portion 404 can be operably coupled by a flexible connecting portion 406.

The flange portion 402 includes inboard face 410 and an outboard face 412. The inboard face 410 of flange portion 402 can abut outboard face 53 of axially shiftable seal ring 36 (also referred to as mating ring herein), creating a pressure tight seal. The outboard face 412 can be contacted by and urged towards the mating ring 30 by retainer 502 and biasing members 506 as discussed above.

Coaxial portion 404 is substantially or entirely radially inward of the balance diameter of the seal, where the pressure differential across the seal is the greatest. Flexible connecting portion 406 can present a thinner cross section than flange portion 402 or coaxial portion 404 to enable stretching and compression.

The inboard face 410 can be formed or modified such that includes one or more inboard depressions 414 formed therein. Such depressions will result in the formation of one more contact points 418 that, in operation, contact the outboard face 53 of axially shiftable seal ring 36 and a recessed face 419 that does not contact outboard face 53 of axially shiftable seal ring 36. As shown, the depression 414 is arranged such only one contact point 418 exists as compared to the two contact points shown above in FIGS. 3A/3B.

As compared to the embodiment of FIG. 2, having the depression/recessed face will result in reduced contact area between the outboard face 53 of axially shiftable seal ring 36 and the inboard face 410 of the membrane 401.

Similar to the above, portions of the outboard face 412 and the coaxial portion 404 can be removed (or otherwise formed to have less material than membrane 100). While shown in the same figure, it shall be understood that removal of portions of the inboard face 410 can be done without removal of portions outboard face or the coaxial portion. That is, while removal is shown to all three portions of the membrane 401, any combination of the three possibilities (or only one) is contemplated as being within the scope of the disclosure.

As shown, an outboard depression 420 is formed in the outboard face 412 to create an outboard recessed surface 421.

In FIG. 4B, the flange portion 402 is shown as having a flange thickness T_{f} measured between the furthest inboard and outboard faces 410, 412 of the flange. The inboard depression 414 is formed such that a distance (thickness) from the recessed face 419 to the outboard face 412 is less than the flange thickness T_{f}. Similarly, the outboard depression 412 is formed such a distance (thickness) from the outboard recessed face 421 to the inboard face 410 is less than the flange thickness T_{f}. In the case where both inboard and outboard depressions 414, 420 are present, the thickness between the inboard and outboard recessed faces 419, 421 is less than T_{f} or the other thicknesses just described.

In a similar manner, the coaxial portion 404 also can portions removed. Again, while portions of both the coaxial and flange portions 402, 406 are shown as being removed in FIGS. 4A, 4B, embodiments herein do not need both.

The coaxial portion 404 has coaxial thickness T_{c} and as shown, an outer depression 432 is formed in the outer face 430 to create an outboard recessed surface 421. The coaxial portion also in inner depression 436 formed on an inner face 434 of the coaxial portion 404. The coaxial thickness T_{c} is measured between the furthest inner and outer faces 434, 430 of the coaxial portion 404. The inner depression 436 is formed such that a distance (thickness) from the inner recessed face 437 to the outer face 430 is less than the coaxial portion thickness T_{c}. Similarly, the outer depression 432 is formed such a distance (thickness) from the outer recessed face 433 to the inner face 434 is less than the coaxial portion thickness T_{c}. In the case where both inner and outer depressions 432, 436 are present, the thickness between them is less than T_{c} or the other thicknesses just described related to the coaxial portion 404.

In the above example it is noted that removing material (or otherwise forming the above described depressions) from one of both of the outboard face 412 of the flange 402 and inner and/or outer faces 430, 434 of the coaxial portion 404 can make the membrane more flexible at least as compared to the flexibility of the membrane 100 as described above. It can also create a reduction in area which increases contact pressure to provide a better seal.

As above, the sealing membrane 401 is non-collapsible and can comprise a flexible material. Example flexible materials include elastomers such as nitrile, fluroreslastomer, and ethylene propylene rubbers, though other materials can be used.

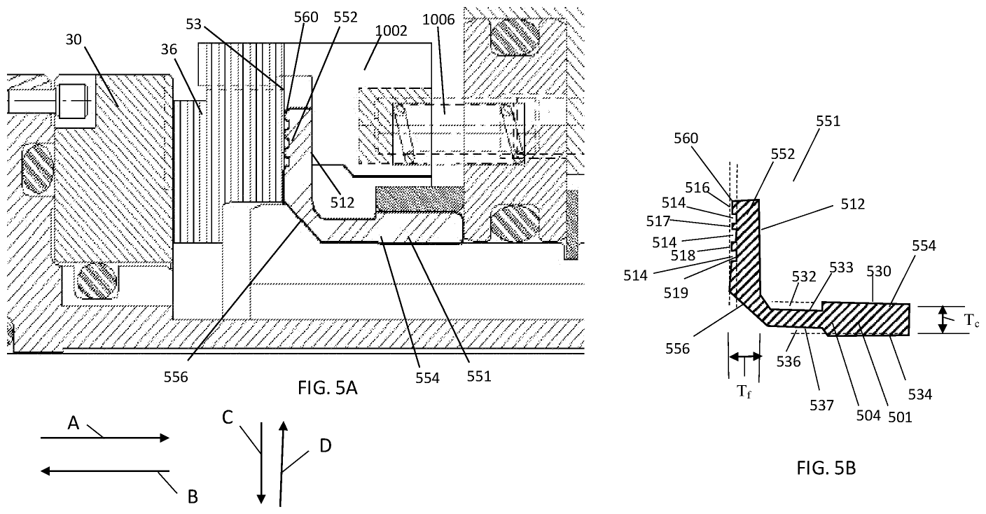

Another embodiment is of a sealing membrane 551 is shown in FIGS. 5A and 5B. In this embodiment, a membrane 551 is illustrated. The membrane 551 can present a generally L-shaped cross-section, comprising a first, generally radially outward extending, flange portion 552 and a second, generally axially outboard extending, coaxial portion 554. Flange portion and coaxial portion 554 can be operably coupled by a flexible connecting portion 556.

The flange portion 552 includes inboard face 560 (generally indicated by the labelled dashed line) and an outboard face 512. In this embodiment, the inboard face 560 of flange portion 552 can abut outboard face 53 of axially shiftable seal ring 36 (also referred to as primary ring herein), creating a pressure tight seal. The outboard face 512 can be contacted by and urged towards the mating ring 30 by retainer 1002 and biasing members 1006 as discussed above relative to elements 502 and 506.

Coaxial portion 554 is substantially or entirely radially inward of the balance diameter of the seal, where the pressure differential across the seal is the greatest. Flexible connecting portion 556 can present a thinner cross section than flange portion or coaxial portion 554 to enable stretching and compression.

The inboard face 560 can be formed or modified such that includes one or more inboard depressions 514 formed therein. Herein, there are shown three depressions 514. These depression can be formed as circular trenches formed in the face 560. Such depressions will result in the formation of one more contact points 516, 517, 518 that, in operation, contact the outboard face 53 of axially shiftable seal ring 36 and a recessed face 519 (formed at the base of the depressions) that does not contact outboard face 53 of axially shiftable seal ring 36.

As compared to the embodiment of FIG. 2, having the depression/recessed face will result in reduced contact area between the outboard face 53 of axially shiftable seal ring 36 and the inboard face 560 of the membrane 501.

Similar to the above, portions of the outboard face 512 and the coaxial portion 554 can be removed. For simplicity, such is not show relative to the outboard face 512 to further illustrate that not all faces need to be modified (or otherwise formed to have less material than membrane 100).

In FIG. 5B, the flange portion is shown as having a flange thickness T_{f} measured between the furthest inboard and outboard faces 560, 512 of the flange. The inboard depression 514 is formed such that a distance (thickness) from the recessed face 519 to the outboard face 512 is less than the flange thickness T_{f}.

In a similar manner to the above embodiments, the coaxial portion 554 also can have portions removed. As illustrated, the coaxial portion 554 has coaxial thickness T_{c} and as shown, an outer depression 532 is formed in the outer face 530 to create an outboard recessed surface 521. The coaxial portion also in inner depression 536 formed on an inner face 534 of the coaxial portion 554. The coaxial thickness T_{c} is measured between the furthest inner and outer faces 534, 530 of the coaxial portion 554. The inner depression 536 is formed such that a distance (thickness) from the inner recessed face 537 to the outer face 530 is less than the coaxial portion thickness T_{c}. Similarly, the outer depression 532 is formed such a distance (thickness) from the outer recessed face 533 to the inner face 534 is less than the coaxial portion thickness T_{c}. In the case where both inner and outer depressions 532, 536 are present, the thickness between them is less than T_{c} or the other thicknesses just described related to the coaxial portion 554.

As above, the sealing membrane 501 is non-collapsible and can comprise a flexible material. Example flexible materials include elastomers such as nitrile, fluroreslastomer, and ethylene propylene rubbers, though other materials can be used.

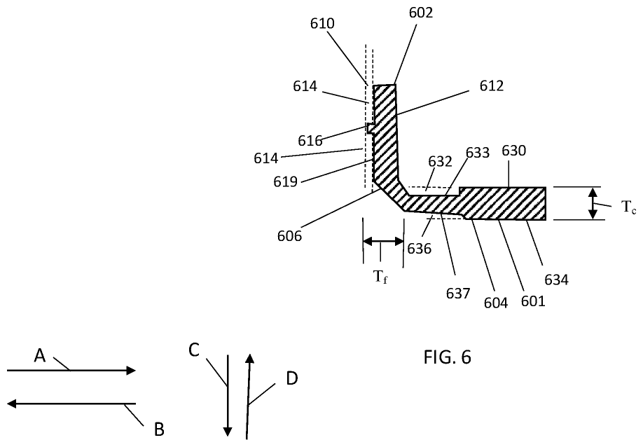

In a similar manner, and as shown in FIG. 6, the sealing membrane can be formed such that it includes two depressions 614 so that a single contact point 616 is formed. In FIG. 6, the other portions of the seal are omitted for brevity. As such, it is understood that the membrane 601 can be used with any prior disclosed seal.

In more detail, the sealing membrane 601 shown in FIG. 6 can present a generally L-shaped cross-section, comprising a first, generally radially outward extending, flange portion 602 and a second, generally axially outboard extending, coaxial portion 604. Flange portion 602 and coaxial portion 604 can be operably coupled by a flexible connecting portion 606.

The flange portion 602 includes inboard face 610 (generally indicated by the labelled dashed line) and an outboard face 612. The inboard face 610 if the furthest inboard face of the flange portion 602 and can be defined at the inboard side of the contact 616.

In this embodiment, the inboard face 610 (an in particular, contact point 616 of flange portion 602) can abut outboard face 53 of axially shiftable seal ring 36 creating a pressure tight seal. The outboard face 612 can be contacted by and urged towards the mating ring 30 by retainer 502 and biasing members 506 as discussed above.

Coaxial portion 604 is substantially or entirely radially inward of the balance diameter of the seal, where the pressure differential across the seal is the greatest. Flexible connecting portion 606 can present a thinner cross section than flange portion 602 or coaxial portion 604 to enable stretching and compression.

The inboard face 610 can be formed or modified such that includes one or more inboard depressions 614 formed therein. Herein, there are shown two depressions 614 in FIG. 6. These depression can be formed as circular trenches formed in the face 610. Such depressions will result in the formation of a single contact ring that, in operation, contacts the outboard face 53 of axially shiftable seal ring 36 and a recessed face 619 (formed at the base of the depressions) that does not contact outboard face 53 of axially shiftable seal ring 36.

As compared to the embodiment of FIG. 2, having the depression/recessed face will result in reduced contact area between the outboard face 53 of axially shiftable seal ring 36 and the inboard face 610 of the membrane 601.

In FIG. 6, the flange portion 602 is shown as having a flange thickness T_{f} measured between the furthest inboard and outboard faces 610, 612 of the flange. The inboard depressions 614 is formed such that a distance (thickness) from the recessed face 619 to the outboard face 612 is less than the flange thickness T_{f}.

In a similar manner to the embodiments, the coaxial portion 604 also can have portions removed. As illustrated, the coaxial portion 604 has coaxial thickness T_{c} and as shown, an outer depression 632 is formed in the outer face 630 to create an outboard recessed surface 633. The coaxial portion also in inner depression 636 formed on an inner face 634 of the coaxial portion 604. The coaxial thickness T_{c} is measured between the furthest inner and outer faces 634, 630 of the coaxial portion 604. The inner depression 636 is formed such that a distance (thickness) from the inner recessed face 637 to the outer face 630 is less than the coaxial portion thickness T_{c}. Similarly, the outer depression 632 is formed such a distance (thickness) from the outer recessed face 633 to the inner face 634 is less than the coaxial portion thickness T_{c}. In the case where both inner and outer depressions 632, 636 are present, the thickness between them is less than T_{c} or the other thicknesses just described related to the coaxial portion 604.

The single contact point 616 can increase contact pressure with an area reduction. This can be accomplished, for example, by forming a single circular ridge as the inboard face 610. This may enable greater control over primary ring pressure distortion by placing the circular contact ridge and sealing point at a position which enables accurate prediction of and control over pressure induced distortion. Indeed, such is true to at least some extent of any prior disclosed embodiment shown in FIGS. 3-5 as well.

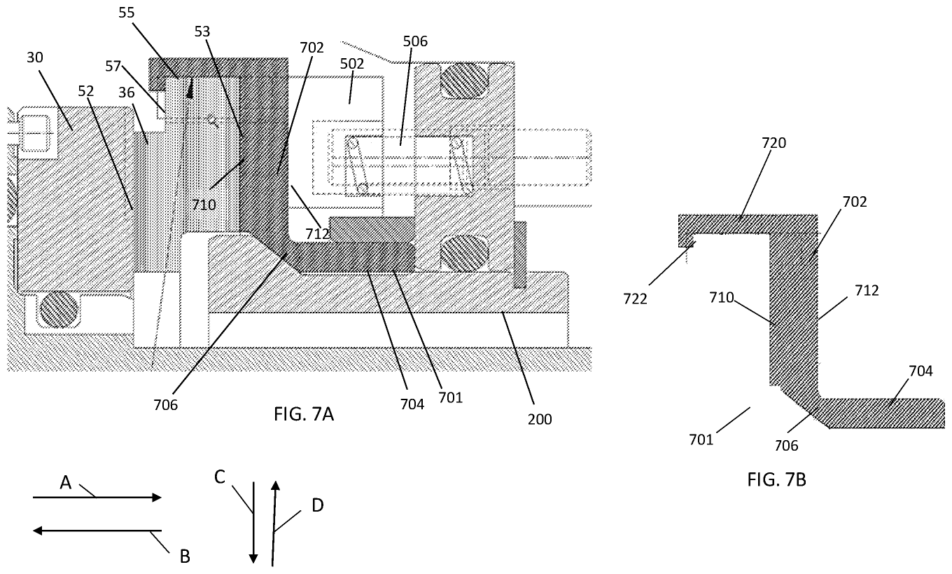

FIGS. 7A and 7B show yet another alternative embodiment of a membrane. This embodiment is similar to that shown in FIGS. 1 and 2 and includes a portion which wraps around the primary ring 36 in order to resist flange deformation and promote sealing between the primary ring and membrane. The membrane of this embodiment can be molded in or formed by removal.

In this embodiment, a membrane 701 is illustrated. The membrane 701 can present a generally L-shaped cross-section, comprising a first, generally radially outward extending, flange portion 702 and a second, generally axially outboard extending, coaxial portion 704. Flange portion 702 and coaxial portion 704 can be operably coupled by a flexible connecting portion 706.

The flange portion 702 includes inboard face 710 and an outboard face 712. The inboard face 710 of flange portion 702 can abut outboard face 53 of axially shiftable seal ring 36 creating a pressure tight seal. The outboard face 712 can be contacted by and urged towards the mating ring 30 by retainer 502 and biasing members 506 as discussed above.

Coaxial portion 704 is substantially or entirely radially inward of the balance diameter of the seal, where the pressure differential across the seal is the greatest. Flexible connecting portion 706 can present a thinner cross section than flange portion 702 or coaxial portion 704 to enable stretching and compression.

The illustrated primary ring 36 includes outboard face 53, inboard sealing face 52 and a membrane contacting face 57 of the region of the inboard sealing face 52 as forms the sealing interface with the mating ring 30. As shown, the inboard sealing face 52 is inboard of the recessed membrane contacting face 57. In other embodiments, the membrane contacting face 57 can be coplanar with or inboard of the inboard sealing face 52 as long as it does not interfere with the formation of sealing interface between the primary and mating rings.

The primary ring also includes an outer face 55 that is radially outward from the inboard sealing face 52 and that connects the outboard face 53 and the membrane contacting face 57. It shall be understood that exact configuration of the primary ring 36 be vary from that shown in FIG. 7A.

The flange portion 702 also includes an outer extension 720 that extends inboard from or relative to the inboard face 710 of the flange portion 702 as shown. The outer extension 720 can optionally also extend from the outboard face 712 of the flange portion 702.

The outer extension 720 can optionally include a radially inward extension 722 that extends radially inward (direction C). The radially inward extension 722 can be arranged and configured so that it contacts the membrane contacting face 57 of the primary ring 36.

As shown, the flange portion 702 contacts the outboard face 53 of the primary ring 36, the outer extension 720 contacts the outer face 55 of the primary ring 53 and the radially inward extension 722 contacts the membrane contacting face 57.

As shown, the membrane 701 wraps around the outer side (outer face 55) and seals to in face formed inboard of the inboard face 710 of the flange (e.g., membrane contacting face 57). This may resist flange deformation and promote sealing between the membrane 701. Optionally, one or more of the outer extension 720 and the radially inward extension 722 can include contour interruptions (e.g., ridges) enabling fewer contact points in the manner described above relative to the inboard face.

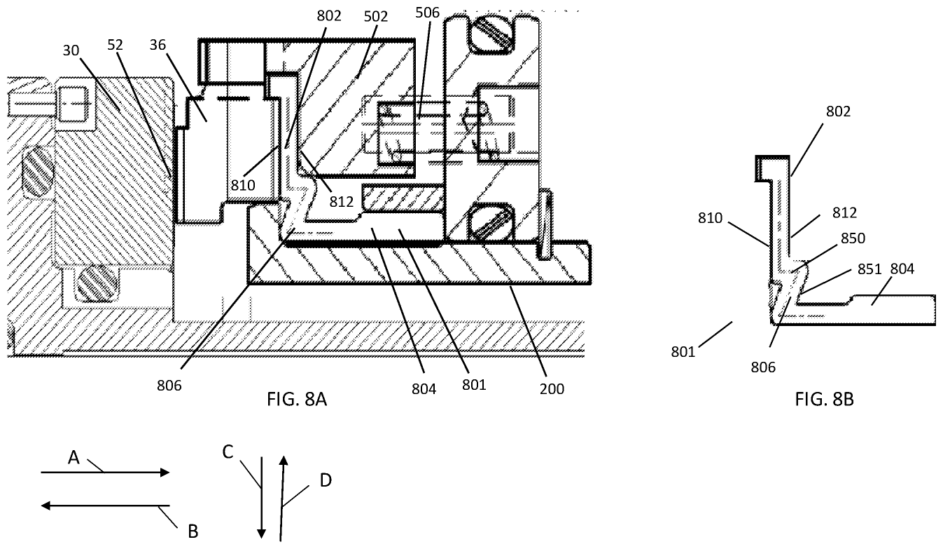

FIGS. 8A and 8B show yet another alternative embodiment of a membrane. This embodiment includes a convolute flexible connecting portion 806. The membrane of this embodiment can be molded in or formed by removal.

In this embodiment, a membrane 801 is illustrated. The membrane 801 can present a generally L-shaped cross-section, comprising a first, generally radially outward extending, flange portion 802 and a second, generally axially outboard extending, coaxial portion 804. Flange portion 802 and coaxial portion 804 can be operably coupled by a flexible connecting portion 806.

The flange portion 802 includes inboard face 810 and an outboard face 812. The inboard face 810 of flange portion 802 can abut outboard face 53 of axially shiftable seal ring 36 creating a pressure tight seal. The outboard face 812 can be contacted by and urged towards the mating ring 30 by retainer 502 and biasing members 506 as discussed above.

In one embodiment, the thickness of the flange portion is less than in prior embodiments. The thickness is between the inboard and outboard faces 810, 812

Coaxial portion 804 is substantially or entirely radially inward of the balance diameter of the seal, where the pressure differential across the seal is the greatest. Flexible connecting portion 806 can present a larger cross section than flange portion 802 and the same or smaller cross section than the coaxial portion 804 to enable stretching and compression.

In contrast to prior embodiments, the flexible connecting portion 806 include a convolute shape. The convolution is provided by the introduction of a small convolution 850 of additional elastomer material extending outwardly form the outboard face 812 of the flange. In one embodiment, the convolution 850 is located at or near a balance diameter of the seal. the connecting portion 806 includes the convolution 850 and an extension 851 that extends from the convolution to the coaxial portion 802. In this manner the connecting portion 806 will join the flange and axial portions.

As illustrated, the connecting portion extends inboard from the convolution 850 to the axial portion. In this manner it will change the transition to the hydraulic balance diameter to a straight vertical from the standard angle as shown above. These elements are intended to improve flexibility and reduce distortion of the membrane 801 through the working height range while maintaining hydraulic balance.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that the subject matter hereof may comprise fewer features than illustrated in any individual embodiment described above. The embodiments described herein are not meant to be an exhaustive presentation of the ways in which the various features of the subject matter hereof may be combined. Accordingly, the embodiments are not mutually exclusive combinations of features; rather, the various embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted.

Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of 35 U.S.C. § 112(f) are not to be invoked unless the specific terms “means for” or “step for” are recited in a claim.

1. A mechanical seal assembly adapted for arrangement around a rotating shaft of a rotating device, the mechanical seal assembly comprises:
a primary ring that, in operation, is axially shiftable relative to the rotating shaft and includes a primary ring seal face and primary ring outboard face;
a mating ring that, in operation, is axially fixed relative to the rotating shaft;
a biasing mechanism that urges the primary ring toward the mating ring to form a seal interface between the primary ring seal face and a seal face of the mating ring with a closing force; and
an annular flexible sealing membrane comprising:
a flange portion arrangeable between the primary ring and the biasing mechanism, the flange portion being axially shiftable relative to the rotating shaft, the flange portion including inboard face and an outboard face,
wherein the inboard face is arranged and configured such that it includes one or more depressions formed therein that form one or more contact regions that contact the primary ring outboard face;
a flexible connection portion positioned within a radially inward extent of the flange portion, wherein the flexible connection portion includes an angular facet that extends from the flexible portion in an axial outward direction; and
a coaxial portion extending axially from the flexible connection portion, the coaxial portion held axially fixed relative to the stub sleeve.

2. The mechanical seal assembly of claim 1, wherein the one or more contact regions define the inboard face and wherein the flange portion includes a flange thickness T_{f} measured between the inboard face and the outboard face.

3. The mechanical seal assembly of claim 2, wherein the inboard face includes at least two depressions and wherein the one or more contact regions includes a single circular contact region formed between the at least two depressions.

4. The mechanical seal assembly of claim 2, wherein the inboard face includes one depression and wherein the one or more contact regions includes two circular contact regions formed on opposing sides of the depression.

5. The mechanical seal assembly of claim 2, wherein the inboard face includes one depression and wherein the one or more contact regions includes a single contact region formed on opposing sides of the depression.

6. The mechanical seal assembly of claim 2, wherein the inboard face includes at least three depressions formed as circles removed or molded into the inboard face and wherein the one or more contact regions includes at least four contact regions.

7. The mechanical seal assembly of claim 1, wherein the depressions define a recessed face in the inboard face and the thickness of the flange portion between the recessed face and the outboard face is less than T_{f}.

8. The mechanical seal of claim 7 any prior claim, wherein the outboard face of the flange portion includes an outboard depression formed therein to define an outboard recessed surface.

9. The mechanical seal assembly of claim 8, wherein a thickness of the flange portion measured between the outboard recessed surface and the inboard face is less than T_{f}.

10. The mechanical seal assembly of claim 1, wherein the coaxial portion includes an outer face and an inner face radially inward from the outer face, where the coaxial portion has a coaxial thickness T_{c} measured between the inner face and the outer face.

11. The mechanical seal assembly of claim 10, wherein the outer surface includes an outer depression formed therein that defines an outer recessed face, wherein a distance between the outer recessed face and the inner face is less that the coaxial thickness T_{c}.

12. The mechanical seal assembly of claim 10, wherein the outer surface include an inner depression formed therein that defines an inner recessed face, wherein a distance between the inner recessed face and the outer face is less that the coaxial thickness T_{c}.

13. A mechanical seal adapted for arrangement around a rotating shaft of a rotating device, the mechanical seal assembly comprises:
a primary ring that, in operation, is axially shiftable relative to the rotating shaft and includes a primary ring seal face and primary ring outboard face;
a mating ring that, in operation, is axially fixed relative to the rotating shaft;
a biasing mechanism that urges the primary ring toward the mating ring to form a seal interface between the primary ring seal face and a seal face of the mating ring with a closing force; and
an annular flexible sealing membrane comprising:
a flange portion arrangeable between the axially shiftable first seal ring and the biasing mechanism, the flange portion being axially shiftable relative to the rotating shaft, the flange portion including an inboard face contacting the primary ring and an outboard face,
wherein the outboard face of the flange portion includes an outboard depression formed therein to define an outboard recessed surface;
a flexible connection portion positioned within a radially inward extent of the flange portion, wherein the flexible connection portion includes an angular facet that extends from the flexible portion in an axial outward direction; and
a coaxial portion extending axially from the flexible connection portion, the coaxial portion held axially fixed relative to the stub sleeve.

14. The mechanical seal of claim 13, wherein the flange portion includes a flange thickness T_{f} measured between the inboard face and the outboard face.

15. The mechanical seal of claim 13 wherein a thickness of the flange portion measured between the outboard recessed surface and the inboard face is less than T_{f}.

16. The mechanical seal of claim 13, wherein the coaxial portion includes an outer face and an inner face radially inward from the outer face, where the coaxial portion has a coaxial thickness T_{c} measured between the inner face and the outer face.

17. The mechanical seal of claim 16, wherein the outer surface includes an outer depression formed therein that defines an outer recessed face, wherein a distance between the outer recessed face and the inner face is less that the coaxial thickness T_{c}.

18. A method of forming an annular flexible sealing membrane for use in a mechanical seal assembly that includes a primary ring, a mating ring and a biasing mechanism that urges the primary ring toward the mating ring to form a seal interface between the primary ring seal face and a seal face of the mating ring with a closing force, the method comprising:
providing an annular flexible sealing membrane that includes:
a flange portion arrangeable between the primary ring and the biasing mechanism, the flange portion being axially shiftable relative to the rotating shaft, the flange portion including inboard face and an outboard face;
a flexible connection portion positioned within a radially inward extent of the flange portion, wherein the flexible connection portion includes an angular facet that extends from the flexible portion in an axial outward direction; and
a coaxial portion extending axially from the flexible connection portion, the coaxial portion held axially fixed relative to the stub sleeve; and
forming one or more depressions in the inboard face to define one or more contact regions configured to contact the primary ring outboard face;
wherein the one or more contact regions define the inboard face and wherein the flange portion includes a flange thickness T_{f} measured between the inboard face and the outboard face.

19. The method according to claim 18 wherein the inboard face includes at least two depressions and wherein the one or more contact region is a single circular contact region formed between the at least two depressions.

20. The method according to claim 18, wherein the inboard face includes one depression and wherein the one or more contact regions are circular and includes two contact regions formed on opposing sides of the depression.

21. The method according to claim 18, wherein the inboard face includes one depression and wherein the one or more contact regions includes a single contact region formed on opposing sides of the depression.

22. The method according to claim 18, wherein the inboard face includes at least three depressions formed as circles removed or molded into the inboard face and wherein the one or more contact regions are circular and includes at least four contact regions.

23. The method according to claim 18, wherein the depressions define a recessed face in the inboard face and the thickness of the flange portion between the recessed face and the outboard face is less than T_{f}.

24. The method according to claim 18, wherein the outboard face of the flange portion includes an outboard depression formed therein to define an outboard recessed surface.

25. The method according to claim 18, wherein a thickness of the flange portion measured between the outboard recessed surface and the inboard face is less than T_{f}.

26. The method according to claim 18, wherein the coaxial portion includes an outer face and an inner face radially inward from the outer face, where the coaxial portion has a coaxial thickness T_{c} measured between the inner face and the outer face.

27. The method according to claim 18, wherein the outer surface includes an outer depression formed therein that defines an outer recessed face, wherein a distance between the outer recessed face and the inner face is less that the coaxial thickness T_{c}.

28. The method according to claim 18, wherein the outer surface include an inner depression formed therein that defines an inner recessed face, wherein a distance between the inner recessed face and the outer face is less that the coaxial thickness T_{c}.

29. A mechanical seal assembly adapted for arrangement around a rotating shaft of a rotating device, the mechanical seal assembly comprises:
a primary ring that, in operation, is axially shiftable relative to the rotating shaft and includes a primary ring seal face, a membrane contacting face radially outward of primary ring seal face, a primary ring outboard face and a primary ring outer face between the primary ring outboard face and the membrane contacting face;
a mating ring that, in operation, is axially fixed relative to the rotating shaft;
a biasing mechanism that urges the primary ring toward the mating ring to form a seal interface between the primary ring seal face and a seal face of the mating ring with a closing force; and
an annular flexible sealing membrane comprising:
a flange portion arrangeable between the primary ring and the biasing mechanism, the flange portion being axially shiftable relative to the rotating shaft, the flange portion including inboard face and an outboard face,
wherein the flange portion includes an outer extension that extends inboard relative to the inboard face and is arranged to contact the primary ring outer face;
a flexible connection portion positioned within a radially inward extent of the flange portion, wherein the flexible connection portion includes an angular facet that extends from the flexible portion in an axial outward direction; and
a coaxial portion extending axially from the flexible connection portion, the coaxial portion held axially fixed relative to the stub sleeve.

30. The mechanical seal assembly of claim 29, wherein the flange portion further includes an inward extension that extends radially inward from the outer extension and contacts membrane contacting face of the primary ring.

31. The mechanical seal assembly of claim 29, wherein the membrane contacting face of the primary ring is outboard of the primary ring seal face.

32. The mechanical seal assembly of claim 29, wherein the membrane contacting face of the primary ring is planer with the primary ring seal face.

33. (canceled)

34. (canceled)

35. (canceled)
